(19) United States
(12) Patent Application Publication
(10) Pub. No.: US 2008/0144884 A1
(43) Pub. Date: Jun. 19, 2008

(54) SYSTEM AND METHOD OF AERIAL SURVEILLANCE

(76) Inventor: Babak Habibi, North Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/779,812

(22) Filed: Jul. 18, 2007

Related U.S. Application Data
(60) Provisional application No. 60/832,356, filed on Jul. 20, 2006.

(51) Int. Cl. G06K 9/00

(52) U.S. Cl. 382/103

(57) ABSTRACT

A system and method for an aerial surveillance system are disclosed. Briefly described, one embodiment comprises a lighter-than-air aerial platform, at least one image capture device carried by the lighter-than-air aerial platform and operable to sequentially capture a plurality of images, and at least one control surface physically coupled to the lighter-than-air aerial platform and operable to control direction of movement of the lighter-than-air aerial platform along a surveillance path in response to a guidance control signal determined in part upon the sequentially captured plurality of images.

### CROSS-REFERENCE TO RELATED APPLICATION

This application claims the benefit under 35 U.S.C. § 119(e) of U.S. Provisional Patent Application No. 60/832,356 filed Jul. 20, 2006, where this provisional application is incorporated herein by reference in its entirety.

### BACKGROUND OF THE INVENTION

1. Field of the Invention

This disclosure generally relates to surveillance systems, and more particularly, to lighter-than-air aerial surveillance systems.

2. Description of the Related Art

There are many different types of airborne surveillance systems. For example, satellite systems provide long-distance visual surveillance or other types of imaging surveillance. However, satellite surveillance systems are very costly to produce and maintain. Further, satellite surveillance systems are limited to surveillance of external environments at very long distances. Accordingly, such long-distance visual surveillance typically provides relatively limited resolution in its captured image data.

Another airborne surveillance device is a drone. A drone is an unmanned, fixed-wing aircraft. Although a drone may provide visual surveillance at relatively close-in distances, the drone must maintain a relatively high minimum velocity to provide adequate lift from its fixed-wing surfaces. Accordingly, drones are not typically appropriate for surveillance of interior regions, such as the relatively confined spaces of the interior of a home, warehouse or the like. Further, drones consume relatively large amounts of fuel and must, therefore, return periodically to a fueling station to refuel.

Yet another type of airborne surveillance device is a rotary-winged device, such as a helicopter. Although a helicopter-based surveillance system may perform surveillance activities at very close-in distances, relatively large amounts of fuel are required to maintain adequate vertical lift from the rotary lift surfaces. Thus, a helicopter-based surveillance system must also return relatively frequently to a fueling station to refuel. Further, helicopter-based surveillance systems are relatively noisy, and therefore, may not be suitable for stealth-like surveillance operations.

Accordingly, although there have been advances in the field, there remains a need in the surveillance arts for an aerial surveillance platform that is operable in an interior environment. The present disclosure addresses these needs and provides further related advantages.

### BRIEF SUMMARY OF THE INVENTION

A system and method for a lighter-than-air aerial surveillance system are disclosed. Briefly described, in one aspect, an embodiment may be summarized as a method that sequentially captures a plurality of images of selected portions of a surveillance region, automatically determines a surveillance path for a lighter-than-air aerial platform through the surveillance region based at least in part upon the sequentially captured plurality of images, and moves the lighter-than-air aerial platform along the determined surveillance path.

In another aspect, an embodiment may be summarized as an aerial surveillance system, comprising a lighter-than-air aerial platform, at least one image capture device carried by the lighter-than-air aerial platform and operable to sequentially capture a plurality of images, and at least one control surface physically coupled to the lighter-than-air aerial platform and operable to control direction of movement of the lighter-than-air aerial platform along a surveillance path in response to a guidance control signal determined in part upon the sequentially captured plurality of images.

In another aspect, an embodiment may be summarized as an aerial surveillance system, comprising at least one lighter-than-air aerial platform, a remote base station communicatively coupled to the lighter-than-air aerial platform via a radio frequency (RF) signal and operable to receive data corresponding to at least one captured image from the lighter-than-air aerial platform, and a remote user station communicatively coupled to the remote base station via a network and operable to receive the at least one captured image. Each of the lighter-than-air aerial platforms comprise at least one image capture device carried by the lighter-than-air aerial platform and operable to sequentially capture a plurality of images, and at least one control surface physically coupled to the lighter-than-air aerial platform and operable to control direction of movement of the lighter-than-air aerial platform along a surveillance path in response to a guidance control signal determined in part upon the sequentially captured plurality of images.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is an isometric view of a lighter-than-air aerial surveillance system monitoring a surveillance area.

FIG. 2 is a close-up isometric view of the surveillance area of FIG. 1.

FIG. 3 is a block diagram of an embodiment of a device platform carried by the lighter-than-air aerial surveillance platform.

FIG. 4 is a block diagram of an embodiment of a base station.

FIG. 5 is a block diagram of an alternative embodiment of a base station.

FIG. 6 is a block diagram of selected modules in the aerial control and surveillance logic for an exemplary embodiment of the lighter-than-air aerial surveillance system.

FIG. 7 is flow chart illustrating an embodiment of a process for aerial surveillance.

### DETAILED DESCRIPTION OF THE INVENTION

In the following description, certain specific details are set forth in order to provide a thorough understanding of various embodiments. However, one skilled in the art will understand that the invention may be practiced without these details. In other instances, well-known structures associated with robotic systems have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open sense, that is as “including, but not limited to.”

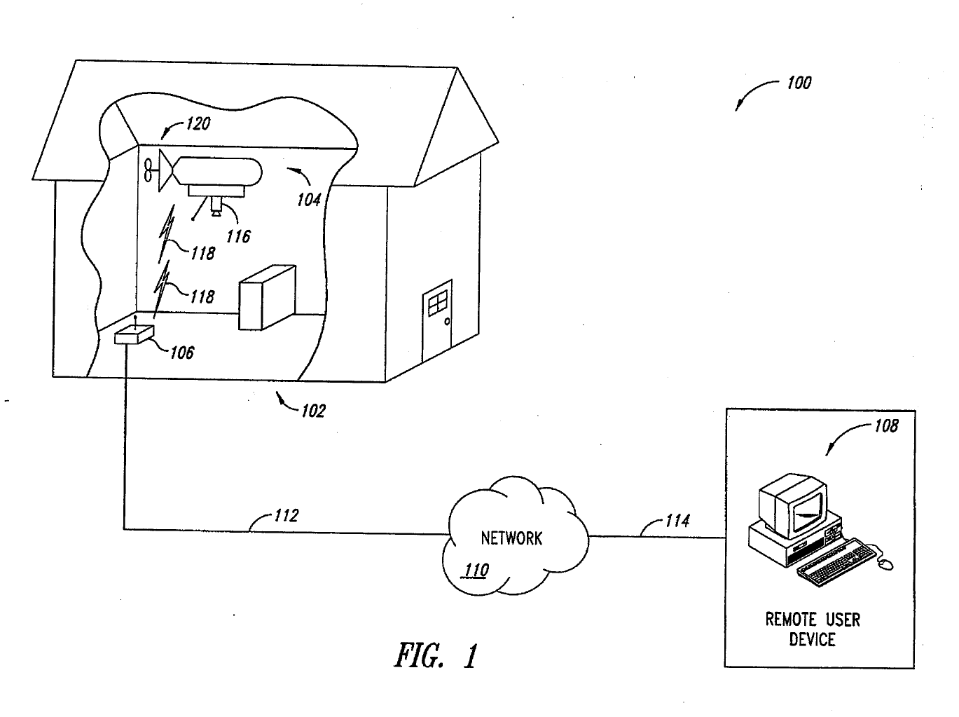

FIG. 1 is an isometric view of an aerial surveillance system 100 monitoring a surveillance area 102. The aerial surveillance system 100 comprises a lighter-than-air aerial platform 104, a base station 106, and a remote user device 108. The base station 106 is communicatively coupled to network 110, via connection 112. Network 110 is communicatively coupled to the remote user device 108, via connection 114. As will be described in greater detail hereinbelow, images captured by an image capture device 116 carried by the lighter-than-air aerial platform 104 are communicated to base station 106 via radio frequency (RF) signals 118.

In the various embodiments of the lighter-than-air aerial surveillance system 100, captured image data is analyzed to dynamically determine guidance commands that move the lighter-than-air aerial platform 104 along a surveillance path. In some embodiments, guidance commands are dynamically determined by systems carried by the lighter-than-air aerial platform 104. In alternative embodiments, a plurality of sequentially captured images are communicated to the base station 106, via RF signals 118. The base station 106 dynamically determines the guidance commands and communicates them back to the lighter-than-air aerial platform 104 such that the lighter-than-air aerial platform 104 is moved along the determined surveillance path.

As will be described in greater detail hereinbelow, the lighter-than-air aerial platform 104 is operable to perform aerial surveillance of an interior region, interchangeably referred to as the surveillance area 102. Examples of interior regions include, but are not limited to, the relatively confined spaces of the interior of a home, warehouse or the like. Some embodiments are operable to perform aerial surveillance of exterior regions, such as parks, zoos, or other exterior regions of interest.

The lighter-than-air aerial platform 104 is self-propelled by a propulsion system 120 such that the lighter-than-air aerial platform 104 may move about the surveillance area 102 at any desirable altitude and/or at a relatively low velocity. Accordingly, guidance commands are determinable to move the lighter-than-air aerial platform 104 in an upward or downward direction, in a left or right direction, in a forward or backward direction, or in any combination of the above directions.

The lighter-than-air aerial platform 104 is buoyant in air. That is, the weight (or density) of the lighter-than-air aerial platform 104 is less that the weight (or density) of the air that it displaces. Accordingly, the lighter-than-air aerial platform 104 may be generally characterized as a device that “floats” in air. In some cases the lighter-than-air aerial platform 104 may be kept aloft using a combination of buoyancy and active lift. The system may switch between buoyancy and active lift to maintain a desired altitude.

Since the lighter-than-air aerial platform 104 is buoyant, a significant amount of fuel is not required to maintain altitude. Altitude adjustments may be implemented by non-propulsion means in some embodiments. Further, fuel consumption is relatively low because the lighter-than-air aerial platform 104 may be operated at relatively low velocities. That is, propulsion requirements are primarily directed to providing changes in movement in a desired direction. Since the relatively low velocities of the lighter-than-air aerial platform 104 translate into relatively low air friction and attendant windage losses, the propulsion system 120 need only provide a relatively low amount of force to sustain movement of the lighter-than-air aerial platform 104. Accordingly, the propulsion system 120 is primarily used to accelerate the lighter-than-air aerial platform 104 to establish momentum in a desired direction at a relatively low speed. The propulsion system 120 is also used to decelerate the lighter-than-air aerial platform 104. As noted above, propulsion system 120 may also be used to adjust altitude, such as by providing an active source of lift for the lighter-than-air aerial platform 104.

Operationally, the lighter-than-air aerial platform 104 moves about the illustrated surveillance area 102 and acquires surveillance information, such as a plurality of successively captured images acquired by the image capture device 116. The surveillance information is communicated to base station 106, described in greater detail hereinbelow. Surveillance information may be processed on-board by systems carried by the lighter-than-air aerial platform 104, and/or may be processed by the base station 106, depending upon the embodiment.

In some embodiments, the acquired surveillance information is communicated to a remote user device 108, via network 110. For convenience, the remote user device 108 is illustrated as a personal computer. However, remote user device 108 may be any suitable access device. Non-limiting examples of different embodiments of the remote user device 108 include a personal device assistant (PDA), a telephone, a pager, a cell phone, or the like.

The remote user device 108 may be at any suitable remote location. For example, the remote user device 108 may be at a manned security center. The security center may be on-site, such as when a security center provides security for a plurality of co-located warehouses, offices, or other structures using one or more lighter-than-air aerial platforms 104. Or, the security center may be remote, such as when the warehouses, offices, or other structures are not co-located.

In some embodiments, the acquired surveillance information may be communicated to a website, via network 110. Accordingly, a user may access the acquired surveillance information that has been posted at the website.

Embodiments may be suitable for providing security to homes or the like. The acquired surveillance information may be communicated to a remote, manned central security center, as described above. Alternatively, or in addition to, the acquired surveillance information may be communicated to an individual's PC, PDA, telephone, pager, cell phone, or the like. For example, if an alarm condition occurs, described in greater detail below, an interested individual such as a homeowner may be directly contacted, via network 110, at their home, office, automobile, or wherever a suitable access device is available.

In some embodiments, a plurality of remote user stations 108 may concurrently, or sequentially, receive the acquired surveillance information. For example, in a home security application, a security service may monitor acquired surveillance information. The acquired surveillance information may also be accessible to the homeowner at their convenience through the above-described website or another type of remote user device 108. During an alarm condition, the acquired surveillance information may be communicated to both the security service and the homeowner(s). Furthermore, different types of surveillance information may be communicated to different remote user devices 108.

In addition to the above-described applications, embodiments of the lighter-than-air aerial platform 104 may be used for other purposes. For example, the lighter-than-air aerial platform 104 may be used for scientific information gathering purposes or recreational purposes. If used in a recreational context, for example, a user might access the above-described website and view captured image data and/or hear acquired audio information. In some embodiments, movement instructions could be provided to the lighter-than-air aerial platform 104 by the user such that the lighter-than-air aerial platform 104 is moved to an area of interest and/or moved in proximity to an object of interest. Such “virtual tours” may be fee-based and allow users to tour museums, zoos or other recreational facilities or locations. Further, virtual tours may be a desirable advertising tool for businesses wishing to entice customers by allowing them to virtually explore a business facility using the lighter-than-air aerial platform 104. It is appreciated that the various possible applications of an aerial surveillance system 100 are nearly limitless, and accordingly, are too numerous to describe in detail herein. All such applications are intended to be included within the scope of this disclosure.

For convenience, network 110 is illustrated and described as a simplified communication system that is, in reality, a very complex communication system. For example, network 110 may be the known telephony system that employs both analog and digital forms of communication. Or the network 110 may be the Internet. Furthermore, the network 110 may be a hybrid system comprised of interacting portions of multiple different types of communication systems. For example, network 110 may be a combination of a telephony system and the Internet. Other illustrative communication systems include radio frequency (RF) wireless systems, satellite systems, microwave systems, and/or cable systems. For example, if network 110 is a conventional telephone system, connections 112 and/or 114 are conventional telephone wires. Data is formatted as an analog signal suitable for communication over the telephone system. As another example, the network 110 may employ RF communications to the remote user device 108 (e.g., cell phone, pager, PDA, or the like). Accordingly, connections 112 and/or 114, illustrated as a hardwire connections for convenience, would be representative of an RF connection between the network 110 and the remote user device 108. Connections 112 and/or 114 may be any suitable wire or wireless connection type.

It is appreciated that the nature of the network 110 with respect to embodiments of the aerial surveillance system 100, as described in detail herein, is relevant to the extent that embodiments may be configured to provide communications in a format that is compatible with the type of network 110 that is being utilized. Accordingly, detailed discussion of the communication of information between the remote user device 108 and the base station 106 over the network 110 may be limited to a general discussion of the various functions and processes used by embodiments of the aerial surveillance system 100.

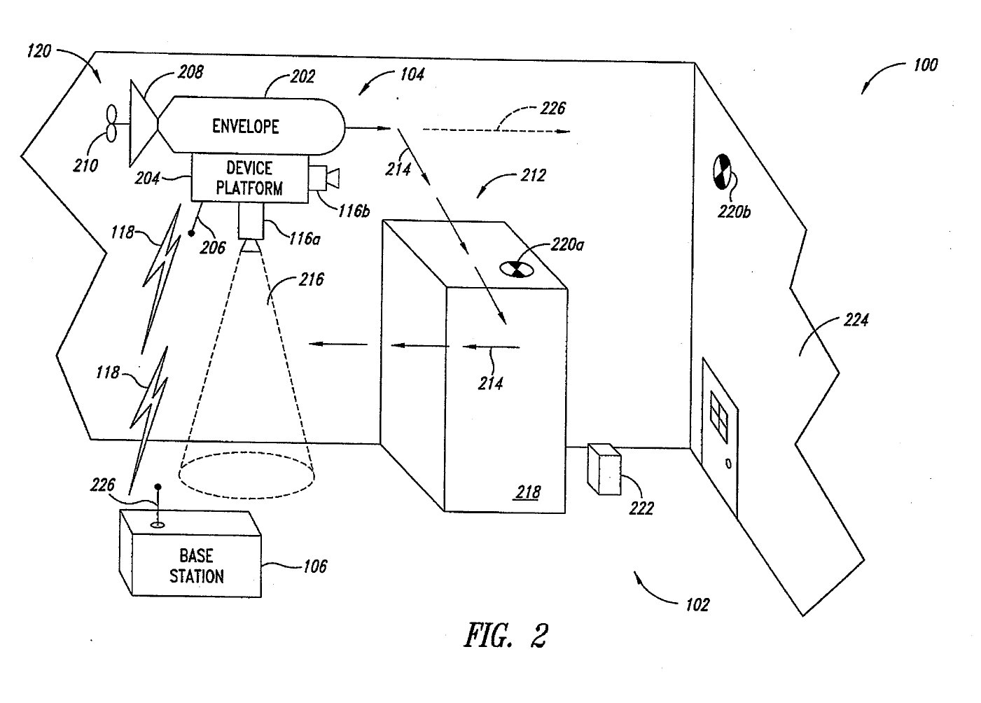

FIG. 2 is a close-up isometric view of the surveillance area 102 of FIG. 1. The lighter-than-air aerial platform 104 is illustrated as patrolling the surveillance area 102. The lighter-than-air aerial platform 104 comprises an envelope 202, a device platform 204, an antenna 206, at least one image capture device 116a, an optional image capture device 116b, and a propulsion system 120. Propulsion system 120 comprises at least one control surface 208 and a propulsion device 210.

The lighter-than-air aerial platform 104 is illustrated as traveling along an initial surveillance path 212, as denoted by the directional arrows 214. Accordingly, the lighter-than-air aerial platform 104 is understood to travel along the initial surveillance path 212 in a forward direction for a relatively brief distance. Then, the lighter-than-air aerial platform 104 turns toward the right and travels for a relatively longer distance. Finally, the lighter-than-air aerial platform 104 then turns again toward the right to travel in a reverse direction.

In embodiments employing the illustrated image capture device 116a, the surveillance region 216 corresponds to the visual field-of-view of the image capture device 116a. Here, for convenience, the image capture device 116a is illustrated as being oriented in a downward direction such that the surveillance region 216 is directly below the lighter-than-air aerial platform 104. As the lighter-than-air aerial platform 104 traverses along the illustrated initial surveillance path 212, it is appreciated that the surveillance region 216 will generally traverse along a similar path.

Preferably, or alternatively, embodiments of the lighter-than-air aerial platform 104 employ one or more image capture devices 116 mounted in moveable enclosures (not shown) which provide for rotational, pan and/or tilt movement of the image capture device 116. Accordingly, the surveillance region 216 may be oriented in any desirable direction by movement of the image capture device 116. In some embodiments, a plurality of image capture devices 116 are employed to provide additional surveillance regions, and/or to provide stereo viewing for surveillance region 216. Also, the surveillance region 216 may be adjusted to be different than the above-described surveillance path 212.

As noted above, image capture device 116a captures a plurality of images. Image capture device 116a may be a camera type device that captured single images, or a video type device that captures video images. Image data captured by the image capture device 116a is interchangeably referred to herein as the acquired surveillance information. The acquired surveillance information may include other types of information as well.

Image capture devices 116 may provide other functionality. In the various embodiments, movement around the surveillance area 102 is based upon visual information. Accordingly, a second image capture device 116b (FIG. 2) may be mounted in a fixed, forward-facing orientation to provide image information for determining the surveillance path of the lighter-than-air aerial platform 104. Additional image capture devices 116 may be used to provide image information in other directions to enhance navigational capability. Or, the image capture device 116b, for example, may be moved in a predefined manner, such as sweeping or panning across the direction of travel, to provide a greater range of view for navigation purposes.

Image capture devices/sensors may be mounted at locations in the environment (other than on the lighter-than-air aerial platform 104). Such image capture devices/sensors may provide the aerial surveillance system 100 with information about the location of the lighter-than-air aerial platform 104 as it moves around in the surveillance area 102.

In some embodiments, object avoidance capability is provided. Such object-avoidance capability is desirable when the surveillance area 102 includes one or more obstacles 218. In such embodiments, object avoidance is based in part upon visual information captured from the forward-facing image capture device 116b, from the illustrated image capture device 116a, and/or from other image capture devices. In some embodiments, acoustic devices, radar devices, and/or other electromagnetic energy-based devices may be used to acquire additional information relevant to object avoidance.

Captured image information may be analyzed using any suitable edge determination algorithm and/or suitable object identification and location algorithm. Determined edges and/or identified objects may then be used to establish the relative position between the lighter-than-air aerial platform 104 and any identified obstacles 218, referred to hereinafter as “range information” for convenience. Once the range information is determined, object avoidance algorithms may be used to dynamically adjust the surveillance path of the lighter-than-air aerial platform 104 to avoid the identified obstacle.

In some embodiments, one or more targets 220 may be used to provide additional range information. For example, a detected target 220 may be used to determine range information by analysis of the visual characteristics of the target 220 such as size and/or orientation. If the location of target 220a on the obstacle 218 is known, the range information between the lighter-than-air aerial platform 104 and the obstacle 218 may be determinable with a very high degree of accuracy.

Further, targets 220 may be located at other convenient locations, such as, but not limited to, floor and/or wall surfaces, objects of interest 222, the base station 106, or a fueling station (not shown). For illustration purposes, target 220b is illustrated on the surface of wall 224. Accordingly, if target 220b is associated with the wall 224, the lighter-than-air aerial platform 104 determines a new surveillance path to avoid the wall in response to detecting the target 220b. The current surveillance path would then be modified by the dynamically determined new surveillance path.

As another non-limiting example of using a target 220, a target 220 may be associated with an object of interest such that the lighter-than-air aerial platform 104 captures one or more images in response to detecting the target 220. The captured image data may be communicated back to the base station 106 and/or the remote user device 108.

For convenience of illustration, the targets 220a and 220b are illustrated as round circular patterns with colored quartiles. Such targets may be painted onto, or be a label affixed to, a location of interest. In other embodiments, targets 220 may be any identifiable feature, such as an edge or other geometrical structure or pattern. For example, a target 220 may be a three-dimensional structure such as a beacon or the like. Or, the target 220 may be a multipurpose device having other functionality, such as a light fixture, fire alarm switch, light switch, door, package label, etc. It is appreciated that the possible types and/or forms of a target 220 are nearly limitless and too numerous to described in detail herein. All such embodiments are intended to be included within the scope of this disclosure. Targets may also be “active” devices that emit detectable information, such as, but not limited to, a known light frequency/strobe pattern, laser signals, or radio signals. Such active targets may be useful beacons for the various purposes. For example, positional information may be recalibrated based upon detection of an active beacon in an alternative embodiment.

Machine-readable indicia may be included on a target 220 to provide additional information of interest. For example, if target 220a includes machine-readable information pertaining to the obstacle 218, the information therein may be used to identify characteristics of the obstacle. Alternatively, the machine-readable information may be an identifier used to obtain the information from a look-up table or the like. Exemplary types of information of interest may include size, shape, weight and/or contents of an object of interest.

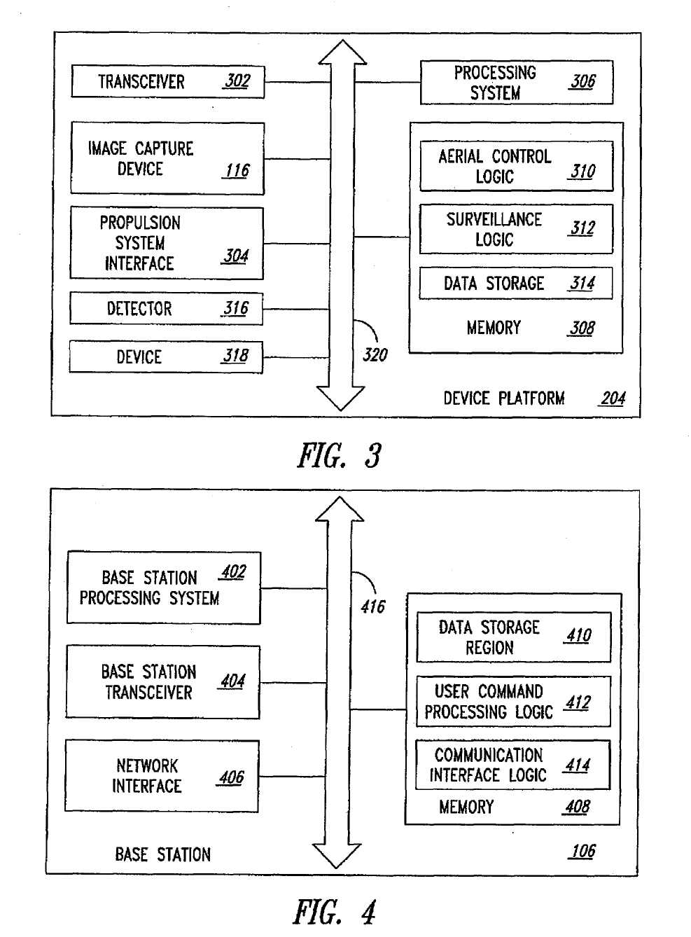

Embodiments of the lighter-than-air aerial platform 104 may additionally or alternatively include other types of detectors 316 (FIG. 3). Exemplary detectors 316 include radar detection systems, acoustic detection systems, and/or other detection devices that employ electromagnetic energy. These detectors 316 may provide supplemental surveillance information or establish range information. Such devices may provide acoustic information, radar information, and/or other electromagnetic-based information.

Accordingly, such embodiments having object avoidance capability are operable to independently move about the surveillance area and avoid encountered obstacles. For example, as illustrated in FIG. 2, if the lighter-than-air aerial platform 104 is approaching the obstacle 218, range information between the lighter-than-air aerial platform 104 and the obstacle 218 is determined from captured image information and/or from information available from detectors 316. In the event that the lighter-than-air aerial platform 104 determines that it had insufficient altitude to pass over the obstacle 218, the lighter-than-air aerial platform 104 could increase its altitude so that it passed over the obstacle 218 as the lighter-than-air aerial platform 104 travels along the illustrated initial surveillance path 212. Or, the surveillance path could be dynamically modified such that the lighter-than-air aerial platform 104 travels around the obstacle 218.

Some embodiments of the lighter-than-air aerial platform 104 are operable to dynamically determine its path of movement based upon analysis of captured image information. The determination may be made on-board the lighter-than-air aerial platform 104. In other embodiments of the aerial surveillance system 100, the path of movement is dynamically determined at the base station 106.

Surveillance requests may be received from the remote user station 108. For example, a user may request a surveillance of the object of interest 222. The surveillance request may indicate the location of the object of interest 222. Or, the object of interest 222 may be identifiable by some characteristic, such as its shape or an identifying target 220c.

Assuming that the location of the object of interest is known, the surveillance path of the lighter-than-air aerial platform 104 may be dynamically modified in response to a surveillance request. That is, the aerial surveillance system 100 dynamically determines a new surveillance path 226. Accordingly, the lighter-than-air aerial platform 104 will, in this example and as illustrated in FIG. 2, continue traveling forward along the new surveillance path 226 until the object of interest 222 becomes visible in the surveillance region 216. Then, one or more captured images which include an image of the object of interest 222 may be communicated to the base station 106, and then optionally back to the remote user device 108.

In some situations, the location of the object of interest may not be known. In such situations, the lighter-than-air aerial platform 104 continues along its surveillance path 212 sequentially capturing images of any objects currently within its surveillance region 216. The captured image data may be analyzed to determine if the object of interest 222 has be located and identified. If so, then the lighter-than-air aerial platform 104 may indicate that the object of interest 222 has been located, may communicate the captured images of the object of interest, and/or perform other surveillance tasks on the object of interest 222.

However, if the object of interest 222 has not been found after traversal of the surveillance path 212, some embodiments of the surveillance system 100 may dynamically determine a new surveillance path. The determination may be based upon analysis of the previously traversed surveillance path to identify locations that were excluded. Or, any suitable search pattern or operation may be implemented. For example, a grid-type search may be implemented where portions of the surveillance area are methodically searched in greater detail. The dynamic determination of new surveillance paths may be made on-board the lighter-than-air aerial platform 104 and/or at the base station 106.

Furthermore, supplemental guidance commands may be received from the remote user station 108. For example, the user may indicate that the object of interest 222 may likely be found within a specified portion of the surveillance area 102. Accordingly, the aerial surveillance system 100 may tailor its search in the specified portion of the surveillance area 102.

FIG. 3 is a block diagram of an embodiment of a device platform 204 carried by the lighter-than-air aerial surveillance platform 104. The device platform 204 comprises a transceiver 302, at least one image capture device 116, a propulsion system interface 304, a processing system 306, and memory 308. The aerial control logic 310, the surveillance logic 312, and the data storage region 314 reside in memory 310. Alternative embodiments of the device platform 204 may include an optional detectors 316. Other embodiments may include one or more optional devices 318 for performing at least one predefined task. The above-described components of the device platform 204 are communicatively coupled together via communication bus 320.

Transceiver 302 is communicatively coupled to the antennae 206 (FIG. 2). Transceiver 302 transmits captured image data and/or other detected information to the base station 106. Transceiver 302 further receives information communicated by base station 106.

Data corresponding to the images captured by the various image capture devices 116 carried on the lighter-than-air aerial surveillance platform 104 may be stored into the data storage region 314. The image data may be retrieved by the processing system 306 for analysis and/or for communication to the base station 106 (FIG. 1). For convenience, the data storage region 314 is illustrated as a portion of memory 308. In alternative embodiments, captured image data may be buffered and/or stored in other memory media. For example, image data may be buffered into a memory of an image capture device 116. After buffering, the captured image data may be sent to one of the processing systems 306 or 402 (FIG. 4) for analysis.

Processing system 306, in the illustrated embodiment of FIG. 3, retrieves and executes the aerial control logic 310 to determine the guidance instructions based at least in part on analysis of captured image data that is retrieved from the data storage region 314 or another suitable memory media. The guidance instructions, determined by execution of the aerial control logic 310, are communicated to the propulsion system interface 304. Propulsion system interface 304 is communicatively coupled to one or more actuators (not shown) which operate the control surfaces 208 (FIG. 2). The propulsion system interface 304 formats and communicates the guidance instructions to actuators that control the above-described control surfaces 208 (FIG. 2). Preferably, there are a plurality of control surfaces 208 to control the various directional changes which are made as the lighter-than-air aerial surveillance platform 104 traverses along a surveillance path 212. For example, one of a plurality of control surfaces 208 may be employed to turn the lighter-than-air aerial surveillance platform 104 to the left or to the right, and another control surface 208 may be employed to adjust the attitude of the lighter-than-air aerial surveillance platform 104 in an upward or in a downward direction.

Guidance instructions are also determined which operate one or more propulsion devices 210 (FIG. 2). Such guidance instructions may control the amount of propulsion, thereby controlling speed and/or direction of movement of the lighter-than-air aerial surveillance platform 104. For example, if a propeller is used as the propulsion device 210, guidance control signals may control the rotational velocity of the propeller, thereby controlling the velocity and/or acceleration of the lighter-than-air aerial surveillance platform 104. Guidance control signals may further control the direction of rotation of the propeller such that when the propeller rotates in a first direction, the propeller generates a forward directed thrust, and such that that when the propeller rotates in a second opposite direction, the propeller generates a backwards directed thrust. In some embodiments, propulsion system 120 may comprise a plurality of propellers oriented in one or more directions. If oriented in different directions, operation of the various propellers may control the direction of movement of the lighter-than-air aerial surveillance platform 104. Other propulsion devices, such as air jets or the like, may be employed by some embodiments of the lighter-than-air aerial surveillance platform 104. For the purposes of this disclosure, such propellers and/or other propulsion devices are interchangeably referred to as control surfaces since they employ one or more surfaces within the propulsion device to provide propulsion (e.g., propeller blades or nozzles).

The various embodiments of the aerial surveillance system 100 dynamically analyze the captured image data on a real-time basis, or on a near real-time basis, to determine the current surveillance path. Real-time may be considered to be nearly instantaneous for purposes of this disclosure. Near real-time may be considered to be less than a few seconds. For example, if the lighter-than-air aerial surveillance platform 104 is moving at a relatively slow speed (less than a few miles-per-hour), dynamically determining a new surveillance path in five seconds or less will likely provide sufficient time to implement a course correction to the new surveillance path.

Analysis of image data on a real-time basis or near real-time basis is possible because of the relatively low velocity of the lighter-than-air aerial surveillance platform 104. That is, since the lighter-than-air aerial platform 104 is slowly moving along a surveillance path, sufficient time is available to capture and analyze captured images and determine a new surveillance path. For example, when the presence of an obstacle 218, a wall or other obstruction are identified from analysis of captured image data, sufficient time is available to determine a new surveillance path to avoid collision with the wall. Guidance commands are generated to operate the control surface 208 and/or propulsion device 210, thereby allowing the lighter-than-air aerial surveillance platform 104 to avoid and/or navigate around detected obstacles 218, walls or other obstructions.

Processing system 306, in the illustrated embodiment of FIG. 3, retrieves and executes the surveillance logic 312 to analyze captured image data that is retrieved from the data storage region 314 or another suitable memory media. The surveillance logic 312 may determine various information of interest from the captured images. For example, image data between captured images may be compared to detect movement. Detected movement may be indicative of an intruder or the like. Currently captured image data may be compared with previously captured images to determine scenery changes. A scenery change may be indicative of property theft.

As noted above, other types of detectors 316 may be carried on the lighter-than-air aerial platform 104. Microphones may be used to detect sounds. A detected sound may be indicative of an intruder or the like. Infrared detectors may be used to detect heat. A detected hot spot may be indicative of an intruder or the like. Temperature detectors may be used to detect temperatures. A change in temperature may be indicative of an opened door or the like.

The above described detected movement, scenery changes, or other security related information determined from the captured images or other devices, may be used to generate an alarm condition. The alarm condition may cause one or more captured images to be communicated from the lighter-than-air aerial platform 104 to the remote user device 108 (FIG. 1). An alarm or other suitable signal may also be communicated to the remote user device, or to other remote user devices, to alert an interested party. For example, an alarm condition notification signal may be communicated to a PDA, a pager and/or a telephone, while captured images may be communicated to a PC and/or website.

In selected embodiments, special purpose devices 318 (FIG. 3) may be carried on the lighter-than-air aerial platform 104 such that one or more work operations may be performed. For example, a robotic grasping arm or the like may allow the lighter-than-air aerial platform 104 to grasp the object of interest 222. Or the lighter-than-air aerial platform 104 may carry a marking device, such as a marker or paint spray device, and mark the object of interest 222. Some embodiments may carry lighting devices to light up areas and/or the object of interest 222. Speakers may be carried such that audible information, such as a warning or the like, may be communicated to individuals in the surveillance area 102. It is appreciated that the possible applications for work and/or tasks performed by embodiments of the lighter-than-air aerial platform 104 are nearly limitless and too numerous to described in detail herein. All such embodiments are intended to be included within the scope of this disclosure.

FIG. 4 is a block diagram of an embodiment of a base station 106. Base station 106 comprises a base station processing system 402, a base station transceiver 404, a network interface 406, and a memory 408. A data storage region 410, user command processing logic 412, and communication interface logic 414 reside in memory 408. The above-described components of the base station 106 are communicatively coupled together via communication bus 416.

Base station transceiver 404 is communicatively coupled to the base station antennae 226. Accordingly, base station transceiver 404 receives RF signals 118 from the above-described transceiver 302 (FIG. 3) carried on the lighter-than-air aerial platform 104. Transceiver 404 also communicates information, such as guidance commands or the like received from the remote user device 108, to transceiver 302 in some embodiments.

Network interface 406 communicatively couples the base station 106 with the above-described network 110. Accordingly, communicated information is formatted for communication between the base station 106 and the network 110 by the network interface 406. Because of the numerous different types of networks that the base station 106 may be communicatively coupled to, a detailed description of network interface 406 is not provided herein for brevity. It is appreciated that any suitable network interface 406 may be employed. In some embodiments, a plurality of network interfaces 406 may be used to interface with a plurality of different types of networks 110 that the base station 106 is coupled to.

As noted above, captured image data and/or other detected information is communicated from the lighter-than-air aerial platform 104 to the base station 106. The image data and/or other detected information may be stored into the data storage region 410. The stored image data and/or other detected information may be retrieved by the base station processing system 402 for analysis and/or for communication to one or more remote user stations 108 (FIG. 1). For convenience, the data storage region 410 is illustrated as a portion of memory 408. In alternative embodiments, captured image data and/or other detected information may be buffered and/or stored in other suitable memory media.

The base station processing system 402, in the illustrated embodiment of FIG. 4, retrieves and executes the communication interface logic 414 to determine, in part, where the captured image data and/or other detected information is to be communicated to. Furthermore, the communication interface logic 414 determines the appropriate format to send the information. For example, the format of information communicated to a telephone will be different from the format of information communicated to a PC or website.

In some embodiments, the communication interface logic 414 may be omitted. Here, pre-formatted surveillance information may be communicated out to a single remote user device 108 (or to a plurality of like-formatted user devices 108). The pre-formatted surveillance information may be subsequently re-formatted and communicated to other remote devices by the remote user device 108. Accordingly, the receiving remote user device 108 would perform appropriate formatting and communication operations as necessary.

The base station processing system 402, in the illustrated embodiment of FIG. 4, retrieves and executes the user command processing logic 412 to determine the nature of commands and/or information received from a remote user device 108. As noted above, a surveillance request may be received directing the lighter-than-air aerial surveillance platform 104 to perform surveillance on designated portions of the surveillance area 102. Or, a surveillance request may be received identifying an object of interest 222 for surveillance. In alternative embodiments, the user command processing logic 412 may reside in memory 308 (FIG. 3) such that the nature of commands and/or information received from a remote user device 108 is determined on board the lighter-than-air aerial platform 104.

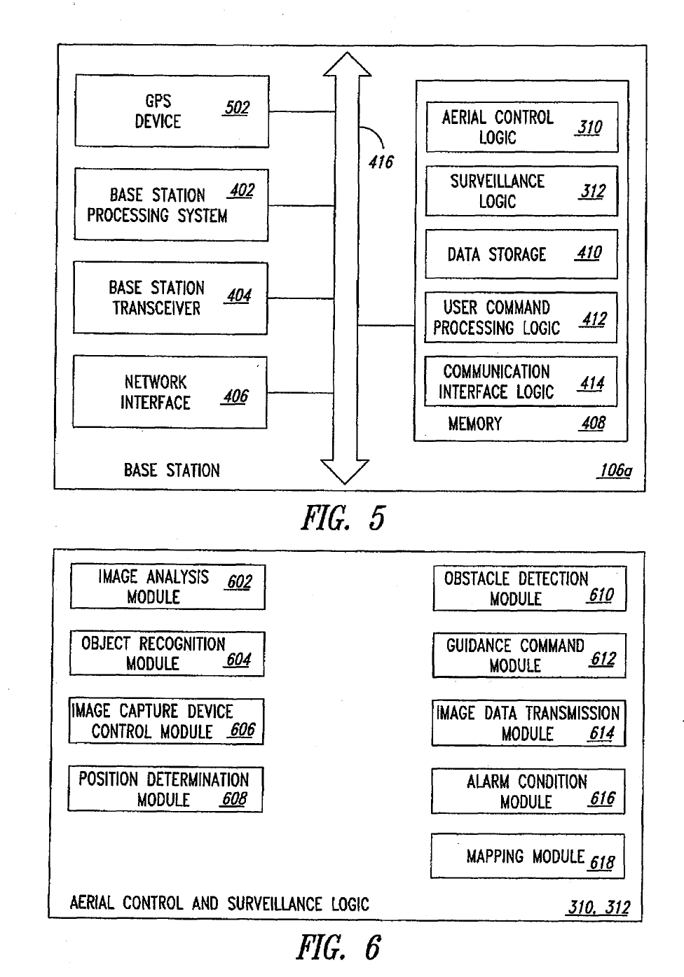

FIG. 5 is a block diagram of an alternative embodiment of a base station 106a. Base station 106a comprises the above-described components in the base station 106 (FIG. 4), plus an optional global positioning system (GPS) device 502. In this exemplary embodiment, further possible alternative configurations are demonstrated. Here, the aerial control logic 310 and the surveillance logic 312 are illustrated as residing in memory 408.

The optional GPS device 502 may be used to precisely identify the location of the lighter-than-air aerial surveillance platform 104. Since location of the lighter-than-air aerial surveillance platform 104 is determinable based upon its known surveillance path and one or more reference locations, location of the lighter-than-air aerial platform 104b and/or location of detected objects of interest may be translated into GPS coordinates. The GPS device 502 may be particularly advantageous during the initial installation of the surveillance system 100, and/or if the base station 106b is portable. In alternative embodiments, the GPS device 502 may be carried on the lighter-than-air aerial surveillance platform 104.

For convenience, the above described components of the device platform (FIG. 3) and the base stations 106 (FIG. 4) and 106a (FIG. 5) are illustrated as communicatively coupled to each other via communication bus 320,416, respectively, thereby providing connectivity between the above-described components. In alternative embodiments, the above-described components are communicatively coupled in a different manner than illustrated in FIGS. 3, 4, and/or 5. For example, one or more of the above-described components may be directly coupled to other components, or may be coupled to each other, via intermediary components (not shown). In some embodiments, communication bus 320 and/or 416 is omitted and the components are coupled directly to each other using suitable connections.

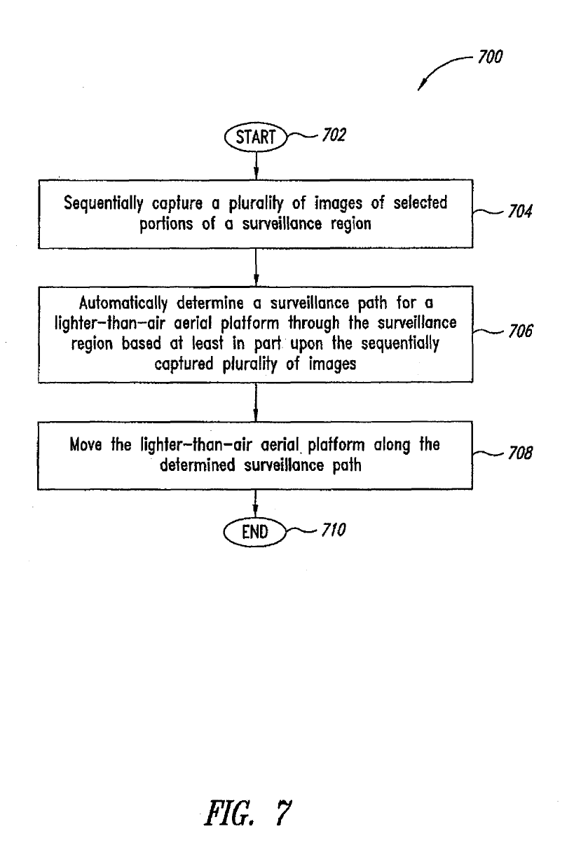

FIG. 6 is a block diagram of selected modules residing in the aerial control and surveillance logic 310, 312 for an exemplary embodiment of the aerial surveillance system 100. For convenience, the aerial control and surveillance logic 310, 312 are illustrated as a single logic unit comprising the illustrated plurality of modules, as compared to FIGS. 3 and/or 5 which illustrate the aerial control logic 310 and the surveillance logic 312 separately. It is appreciated that illustrating the aerial control logic 310 and the surveillance logic 312 separately or together does not affect the functionality of the logic. Such logic could be coded separately, together, or even as part of other logic without departing from the sprit and intention of the various embodiments described herein. All such embodiments are intended to be included within the scope of this disclosure.

The illustrated modules include an image analysis module 602, an object-recognition module 604, an image capture device control module 606, a position determination module 608, a barrier detection module 610, a guidance command module 612, an image data transmission module 614, an alarm condition module 616, and/or mapping module 618. It is appreciated that one or more of the above-described modules may be implemented separately or may be integrated together. Alternative embodiments may not include all of the illustrated modules. Furthermore, other logic and/or modules that are not described herein may be included in the various embodiments. All such embodiments are intended to be included within the scope of this disclosure.

The image analysis module 602 comprises logic operable to analyze captured image data received from one or more image capture devices 116. Any suitable type of image analysis algorithm may be used by the various embodiments described herein. The above-described edge detection algorithm may be included in this exemplary module. Other types of image data post-processing algorithms may be included.

The object-recognition module 604 is operable to identify objects that become visible in the surveillance region 216 (FIG. 2) as the lighter-than-air aerial platform 104 travels along a surveillance path 212. Any suitable object-recognition algorithm may be employed by the various embodiments of the aerial surveillance system 100. Object-recognition algorithms identify known objects by comparing acquired image data with characteristics of the known objects. With embodiments employing the above-described targets 220, object-recognition module 604 may comprise a target recognition algorithm. Some target recognition algorithms are operable to analyze visual characteristics of a detected target to determine a distance and/or orientation from the detected target. Such target recognition algorithms are operable to detect machine-readable information.

Image capture device control module 606 is operable to control various operational aspects of the above-described image capture devices 116a and/or 116b. For example, if rotational, pan, and/or tilt capability is provided for the image capture device 116a, the image capture device control module 606 determines control commands to orient the image capture device 116a in a desired direction. Image capture device control module 606 may control other image capture device functions such as, but not limited to, focus, zoom, resolution, color correction, and/or contrast correction. Also, the image capture device control module 606 may control the rate at which images are captured.

The position determination module 608 is operable to determine position of the lighter-than-air aerial platform 104. In embodiments employing a GPS device 502 (FIG. 5) residing at the base station 106, the position determination module 608 determines the position of the lighter-than-air aerial platform 104 based upon the known movement of the lighter-than-air aerial platform 104. In embodiments that include the GPS device 502 carried by the device platform 204 (FIG. 2), the position determination module 608 is operable to interpret information received from the GPS device 502.

In some embodiments, position determination module 608 is operable to interpret the determined position of the lighter-than-air aerial platform 104 in the context of the surveillance area 102. That is, the lighter-than-air aerial platform 104, when performing surveillance operations in a home, may determine where in the home the lighter-than-air aerial platform 104 is currently located. For example, if the lighter-than-air aerial platform 104 is conducting surveillance operations in the living room, the surveillance region 216 may be interpreted to be a portion of the living room. Thus, the communicated acquired surveillance information may include information indicating the determined location along with captured image data.

Obstacle detection module 610 is operable to determine the presence of various types of obstacles, such as obstacle 218 or wall 224 (FIG. 2), as the lighter-than-air aerial platform 104 travels along a surveillance path. As noted above, some embodiments detect the presence of the obstacle based upon analyzed captured image data. Other embodiments may detect the presence of an obstacle based upon information received from one or more devices 318 (FIG. 3) as described above.

The guidance command module 612 is operable to determine the actual control signals, referred to as the guidance command signals herein, that are communicated to the above-described control surface 208 and/or to the propulsion device 210 (FIG. 2). The guidance command module 612 receives information from one or more of the above-described modules and/or from a surveillance request received from a remote user device 108. Then, the guidance command module 612 determines the actual control signals so that the lighter-than-air aerial platform 104 travels along the dynamically determined surveillance path.

Image data transmission module 614 is operable to format acquired surveillance information into suitable formats for transmission to the base station 106 and/or a remote user device 108. Accordingly, the image data transmission module 614 operates in cooperation with information received from the image analysis module 602, in some embodiments. In some embodiments, the image data transmission module 614 receives image data from the image capture device 116a and/or 116b, and formats the image data for communication to the base station 106.

Alarm condition module 616 is operable to determine an occurrence of an alarm condition. Alarm conditions correspond to situations that may be of interest to a user at a remote user device 108. Alarm conditions are situations that the user should be notified of. For example, the presence of an intruder may be determined based upon detected movement apparent from the analysis of a plurality of sequentially captured images. As another nonlimiting example, a change in temperature may indicate an opened door or the like. Accordingly, the alarm condition module 616, upon determination of the alarm condition, initiates transmission of the determined alarm condition, and/or any corresponding acquired surveillance information, to the appropriate remote user device 108. As noted above, image capture data may be included as part of the alarm condition information.

Mapping module 618 is operable to track and/or map current position, past position, and intended future position of the as the lighter-than-air aerial platform 104 travels along a surveillance path. For example, if the surveillance path corresponds to a path of interest about a warehouse or other known enclosure, mapping module 618 may provide directional information such that the lighter-than-air aerial platform 104 travels along a surveillance path of interest. Accordingly, the mapping module 618 may include a predefined surveillance path of interest. The mapping module 618 may be updated to have a new or revised surveillance path of interest, such as when the lighter-than-air aerial platform 104 is conducting surveillance in a different warehouse, or if objects in the warehouse have been moved such that an updated surveillance path of interest is desirable.

FIG. 7 is a flow chart 700 illustrating an embodiment of a process for aerial surveillance. The flow chart 700 shows the architecture, functionality, and operation of various embodiments for implementing at least one portion of the logic 310, 312 (FIGS. 3 and/or 5). An alternative embodiment implements the logic of flow chart 700 with hardware configured as a state machine. In this regard, each block may represent a module, segment or portion of code, which comprises one or more executable instructions for implementing the specified logical function(s). It should also be noted that in alternative embodiments, the functions noted in the blocks may occur out of the order noted in FIG. 7, or may include additional functions. For example, two blocks shown in succession in FIG. 7 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included within the scope of this disclosure.

The process illustrated in FIG. 7 begins at block 702. A plurality of images of selected portions of a surveillance region are sequentially captured at block 704. A surveillance path for a lighter-than-air aerial platform is automatically determined through the surveillance region based at least in part upon the sequentially captured plurality of images at block 706. The lighter-than-air aerial platform is moved along the determined surveillance path at block 708. The process ends at block 710.

In the above-described various embodiments, RF communications between the lighter-than-air aerial surveillance platform 104 and the base station 106 (FIG. 1) were used to communicate captured image data and other information. In alternative embodiments, other suitable communication apparatus and systems may be employed. For example, line of sight communication systems, such as infrared, may be used.

Alternative embodiments of the aerial surveillance system 100 may employ a plurality of base stations 106 in communication with the lighter-than-air aerial surveillance platform 104. Multiple base stations 106 may be advantageous if the RF signals 118 are low power signals detectable over limited distances, if one or more obstacles 218 (FIG. 2) obstruct communications, and/or if the surveillance area 102 is relatively large.

Alternative embodiments of the aerial surveillance system 100 may receive information from various types of sensors to obtain information that may be used to automatically determine a surveillance path for the lighter-than-air aerial platform 104 through the surveillance area 102, based at least in part upon the acquired information. For example, video information may be acquired from video cameras. Other embodiments may acquire acoustic information and/or images from sonar devices or may acquire thermal information and/or images from a laser scanner device. Such information may be used independently, or may supplement the above-described image analysis. Such information may additionally be used to determine and/or confirm the location of the lighter-than-air aerial surveillance platform 104. Other examples of information include GPS, Radio/Laser Beacons, RF Tags and readers and the like.

Users may be able to remotely “drive” the system manually in alternative embodiments of the aerial surveillance system 100 by providing control signals to the guidance command module 612 (FIG. 6) or by specifying locations of interest (wherein the aerial control logic 310 may determine relative position of the lighter-than-air aerial surveillance platform 104 within the surveillance area 102 with respect to the specified location of interest).

In some embodiments, the user may also instruct the system to “play back” a pre-programmed sequence of actions in real time or at pre-programmed intervals. For example, the user may instruct the aerial surveillance system 100 to go to warehouse bay #4 and capture images of containers 5 thru 11 (using a Macro or the like that may be pre-programmed into the aerial control logic).

Alternative embodiments of the aerial surveillance system 100 may employ be equipped with manipulators and/or communication means to interact with other systems or devices in the environment. For example, alternative embodiments of the aerial surveillance system 100 may communicate and/or interact with other security systems, fire prevention systems, HVAC systems or the like.

Multiple units of the system of the aerial surveillance system 100 may be deployed and/or controlled to act in coordination to accomplish a given task or sequence of actions (i.e., as a team). For example, a first lighter-than-air aerial surveillance platform 104 may obtain information for one side of an object of interest, and a second lighter-than-air aerial surveillance platform 104 may obtain additional information on another side of the object of interest. As another example, if one lighter-than-air aerial surveillance platform 104 includes a manipulator that is performing a task, as second lighter-than-air aerial surveillance platform 104 could observe progress of the performed task.

Alternative embodiments of the aerial surveillance system 100 may also be equipped with other sensing devices unrelated to determining a surveillance path for the lighter-than-air aerial platform 104 through the surveillance area 102. For example, detectors may be added to sense temperature, humidity, smoke, carbon monoxide, radiation, sound, or the like.

Alternative embodiments of the aerial surveillance system 100 may employ a plurality of lighter-than-air aerial surveillance platforms 104 in communication with one or more base stations 106. Multiple lighter-than-air aerial surveillance platforms 104 may be advantageous if there are many objects of interest which are regularly monitored, if there are a relatively large number of entrances or exits that require monitoring, and/or if the surveillance area 102 is relatively large.

In the above-described various embodiments, the processing systems 306 and/or 404 (FIGS. 3-5) may employ a microprocessor, a digital signal processor (DSP), an application specific integrated circuit (ASIC) and/or a drive board or circuitry, along with any associated memory, such as random access memory (RAM), read only memory (ROM), electrically erasable read only memory (EEPROM), or other memory device storing instructions to control operation.

The above description of illustrated embodiments, including what is described in the Abstract, is not intended to be exhaustive or to limit the invention to the precise forms disclosed. Although specific embodiments of and examples are described herein for illustrative purposes, various equivalent modifications can be made without departing from the spirit and scope of the invention, as will be recognized by those skilled in the relevant art. The teachings provided herein of the invention can be applied to other lighter-than-air surveillance systems, not necessarily the exemplary lighter-than-air surveillance system embodiments generally described above.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the control mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

Reference throughout this specification to “one embodiment” or “an embodiment” means that a particular feature, structure or characteristic described in connection with the embodiment is included in at least one embodiment of the present systems and methods. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

From the foregoing it will be appreciated that, although specific embodiments of the invention have been described herein for purposes of illustration, various modifications may be made without deviating from the spirit and scope of the invention. Accordingly, the invention is not limited except as by the appended claims.

These and other changes can be made to the present systems and methods in light of the above-detailed description. In general, in the following claims, the terms used should not be construed to limit the invention to the specific embodiments disclosed in the specification and the claims, but should be construed to include all surveillance systems and methods that read in accordance with the claims. Accordingly, the invention is not limited by the disclosure, but instead its scope is to be determined entirely by the following claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

1. An aerial surveillance method, the method comprising:
sequentially capturing a plurality of images of selected portions of a surveillance region;
automatically determining a surveillance path for a lighter-than-air aerial platform through the surveillance region based at least in part upon the sequentially captured plurality of images; and
moving the lighter-than-air aerial platform along the determined surveillance path.

2. The method of claim 1, further comprising:
processing the plurality of sequentially-captured images using a processing system carried on the lighter-than-air aerial platform; and
determining at least one guidance command to move the lighter-than-air aerial platform along the determined surveillance path.

3. The method of claim 1, further comprising:
communicating the plurality of sequentially-captured images to a remote base station;
processing the plurality of sequentially-captured images using a processing system residing in the remote base station;
dynamically determining at least one guidance command to move the lighter-than-air aerial platform along the determined surveillance path; and
communicating the at least one guidance command to the lighter-than-air aerial platform.

4. The method of claim 3, further comprising:
communicating the plurality of images over a network from the remote base station to a remote user station;
receiving at least one user specification identifying a location of interest in the surveillance region;
dynamically determining a second surveillance path for the lighter-than-air aerial platform through the surveillance region, wherein the second surveillance path starts from a current location of the lighter-than-air aerial platform and ends at the location of interest; and
moving the lighter-than-air aerial platform to the location of interest along the determined second surveillance path.

5. The method of claim 4, further comprising:
capturing at least one image of the location of interest;
communicating the at least one image of the location of interest to the remote base station; and
communicating the at least one image of the location of interest over the network to the remote user station.

6. The method of claim 4 where, in response to arriving at the location of interest, further comprising:
performing a task with the lighter-than-air aerial platform at the location of interest.

7. The method of claim 4 wherein communicating the plurality of images over the network further comprises:
accessing the remote user station using a dial-up connection.

8. The method of claim 4 wherein communicating the plurality of images over the network further comprises:
accessing an Internet; and
communicating the plurality of images to a website.

9. The method of claim 1, further comprising:
analyzing at least one of the plurality of sequentially-captured images to identify at least one location marker residing in the surveillance region;
dynamically determining a second surveillance path which avoids the detected at least one location marker; and
dynamically modifying the surveillance path to the second surveillance path such that the lighter-than-air aerial platform moves along the second surveillance path to avoid the detected at least one location marker.

10. The method of claim 1, further comprising:
analyzing at least one of the plurality of sequentially-captured images to identify at least one location marker residing in the surveillance region;
capturing an image of a region of interest that is associated with the at least one detected location marker; and
communicating the image of the region of interest to a remote base station.

11. The method of claim 1, further comprising:
analyzing at least one of the plurality of sequentially-captured images to identify at least one obstacle residing in the surveillance region;
dynamically determining a second surveillance path which avoids the detected at least one obstacle; and
dynamically modifying the surveillance path to the second surveillance path such that the lighter-than-air aerial platform moves along the second surveillance path to avoid the detected at least one obstacle.

12. The method of claim 1, further comprising:
receiving movement instructions from a remote base station;
dynamically determining a second surveillance path that modifies the surveillance path in accordance with the received movement instructions; and
moving the lighter-than-air aerial platform along the determined second surveillance path.

13. The method of claim 1, further comprising:
dynamically analyzing at least one of the plurality of sequentially-captured images to detect presence of an alarm condition;
where, in response to detecting a presence of the alarm condition, communicating at least one analyzed image associated with the alarm condition to a remote base station.

14. The method of claim 13 wherein communicating the plurality of images to the remote base station comprises:
communicating an alarm associated with the detected alarm condition to the remote base station.

15. The method of claim 1, further comprising:
receiving a surveillance request to locate an object of interest;
dynamically determining a second surveillance path that modifies the surveillance path in accordance with a search pattern for locating the object of interest;
moving the lighter-than-air aerial platform along the determined second surveillance path;
analyzing the sequentially captured plurality of images captured while moving along the determined second surveillance path until the object of interest is identified; and
communicating at least one captured image of the object of interest to a remote base station.

16. An aerial surveillance system, comprising:
a lighter-than-air aerial platform;
at least one image capture device carried by the lighter-than-air aerial platform and operable to sequentially capture a plurality of images; and
at least one control surface physically coupled to the lighter-than-air aerial platform and operable to control direction of movement of the lighter-than-air aerial platform along a surveillance path in response to a guidance control signal determined in part upon the sequentially captured plurality of images.

17. The aerial surveillance system of claim 16, further comprising:
a processing system carried by the lighter-than-air aerial platform and operable to dynamically generate the guidance control signal such that the lighter-than-air aerial platform independently patrols at least a three-dimensional surveillance region.

18. The aerial surveillance system of claim 17 wherein the surveillance path is determined in part by processing of the sequentially captured plurality of images in at least near real-time by the processing system.

19. The aerial surveillance system of claim 16, further comprising:
an aerial transceiver carried by the lighter-than-air aerial platform and communicatively coupled to the at least one image capture device, and operable to communicate the sequentially captured plurality of images to at least one remote base station on at least a near real-time basis.

20. The aerial surveillance system of claim 19, further comprising:
the at least one remote base station operable to receive at least one of the sequentially-captured images from the aerial transceiver and operable to dynamically generate the guidance control signal on at least the near real-time basis such that the lighter-than-air aerial platform independently patrols at least the surveillance region.

21. The aerial surveillance system of claim 20 wherein the surveillance path is determined in part by processing of the sequentially captured plurality of images on at least the near real-time basis by a processing system.

22. An aerial surveillance system, comprising:
at least one lighter-than-air aerial platform, comprising:
at least one image capture device carried by the lighter-than-air aerial platform and operable to sequentially capture a plurality of images; and
at least one control surface physically coupled to the lighter-than-air aerial platform and operable to control direction of movement of the lighter-than-air aerial platform along a surveillance path in response to a guidance control signal determined in part upon the sequentially captured plurality of images;
a remote base station communicatively coupled to the lighter-than-air aerial platform via a radio frequency (RF) signal and operable to receive data corresponding to at least one captured image from the lighter-than-air aerial platform; and
a remote user station communicatively coupled to the remote base station via a network, and operable to receive the at least one captured image.

23. The aerial surveillance system of claim 22 wherein the remote base station is operable to receive at least one user instruction from the remote user station that identifies at least one location of interest in a surveillance area, and wherein the remote base station comprises:
a processing system operable to dynamically determine a new surveillance path for the lighter-than-air aerial platform, and operable to communicate the new surveillance path to the lighter-than-air aerial platform such that the lighter-than-air aerial platform moves along the new surveillance path to the location of interest.

24. The aerial surveillance system of claim 22 wherein the remote base station comprises:
a processing system operable to analyze the received data corresponding to at least one captured image from the lighter-than-air aerial platform to identify at least one obstacle, and further operable to dynamically determine a new surveillance path for the lighter-than-air aerial platform that avoids the obstacle, such that the new surveillance path is communicated to the lighter-than-air aerial platform which moves along the new surveillance path to avoid the at least one identified obstacle.

25. The aerial surveillance system of claim 22 wherein the least one lighter-than-air aerial platform comprises:
a processing system operable to analyze the at least one captured image from the image capture device to identify at least one obstacle, and further operable to dynamically determine a new surveillance path for the lighter-than-air aerial platform that avoids the obstacle, such that the lighter-than-air aerial platform moves along the new surveillance path to avoid the at least one identified obstacle.

26. An aerial surveillance method, the method comprising:
obtaining information of interest of selected portions of a surveillance region;
automatically determining a surveillance path for a lighter-than-air aerial platform through the surveillance region based at least in part upon the obtained information; and
moving the lighter-than-air aerial platform along the determined surveillance path.

27. The aerial surveillance method of claim 26 wherein obtaining information of interest comprises:
capturing images with an image capture device.

28. The aerial surveillance system of claim 26 wherein obtaining information of interest comprises:
capturing video images with an video camera.

29. The aerial surveillance system of claim 26 wherein obtaining information of interest comprises:
obtaining acoustic information with a sonar device.

30. The aerial surveillance system of claim 26 wherein obtaining information of interest comprises:
laser information with laser scanning device.
